(19) United States
(12) Patent Application Publication
(10) Pub. No.: US 2003/0119457 A1
(43) Pub. Date: Jun. 26, 2003

(54) Filter technique for increasing antenna isolation in portable communication devices

(76) Inventor: Randolph E. Standke, San Diego, CA (US)

Correspondence Address: QUALCOMM Incorporated, Attn: Patent Department, 5775 Morehouse Drive, San Diego, CA, 92121-1714, US

(21) Appl. No.: 10/292,187

(22) Filed: Nov. 11, 2002

Related U.S. Application Data
(60) Provisional application No. 60/343,255, filed on Dec. 19, 2001.

(51) Int. Cl. H04B 1/02

(52) U.S. Cl. 455/103; 455/552

(57) ABSTRACT

Provided is a system and method for eliminating the effects of antenna coupling by increasing the isolation between closely mounted antennas on a portable wireless communications device. Increased isolation is achieved by providing a ceramic resonator in the path of each of the antennas. The ceramic resonator placed in the path of a particular antenna eliminates the effects of coupling caused by a particular one of the other antennas by rejecting signals associated with the particular antenna.

### RELATED APPLICATIONS

This application claims the benefit of provisional U.S. Application Serial No. 60/343,255, entitled “FILTER TECHNIQUE FOR INCREASING ANTENNA ISOLATION IN PORTABLE COMMUNICATION DEVICES,” filed Dec. 19, 2001, which is incorporated herein by reference in its entirety for all purposes.

### BACKGROUND OF THE INVENTION

1. Field of the Invention

This invention generally relates to the field of antenna isolation for wireless communications devices. More particularly, the present invention relates to increasing the isolation between antennas used in a handheld personal communications device, such as those which are used in a code division multiple access (CDMA) based wireless network, and antennas used for Bluetooth transmissions.

2. Description of Related Art

Bluetooth is a wireless communications standard for establishing short-range radio links between personal digital assistants (PDAs), wireless phones, and other portable communication devices, thus eliminating the need for cables and other communications connection mechanisms. Bluetooth provides that a wireless phone and a PDA, for example, each equipped with Bluetooth capability, may be interconnected at short range through a radio frequency (RF) connection based upon Bluetooth communication standards. Inherent in a Bluetooth compatible device is an ability to communicate at Bluetooth communication frequencies, which are within a frequency range of about 2.4 to 2.5 GHz. On the other hand, conventional CDMA based wireless phones, also known as personal communication services (PCS) wireless phones, operate within an RF band of about 1.85 to 1.99 GHz. Therefore, Bluetooth capable wireless phones will require additional circuit components in order to support the Bluetooth capability. One such component is a separate Bluetooth antenna for transmitting and receiving Bluetooth signals. A technical challenge, however, with placing Bluetooth antennas on PCS wireless phones is determining the appropriate location on the phone for placement. An appropriate location would maximize signal reception, but at the same time, would minimize the degree of signal coupling between the Bluetooth and PCS antennas.

As stated above, PCS wireless phones transmit and receive signals within an RF band of about 1.85 to 1.99 GHz. Thus, a separate antenna is needed for providing a Bluetooth communication capability within the stated frequency band. A Bluetooth capable wireless phone, therefore, will require at least two antennas, one for handling PCS frequencies and one for handling Bluetooth frequencies. FIGS. 1 & 2 illustrate two possible antenna configurations for a Bluetooth equipped wireless phone. Each configuration, however, possesses its own unique technical challenge. As shown in FIG. 1, for example, a wireless phone 1 includes a PCS antenna 20 and a Bluetooth antenna 18. In the example of FIG. 1, the PCS antenna 20 is an unbalanced monopole antenna and is mainly limited to placement at the top of the phone 1. The Bluetooth antenna 18, on the other hand, is a chip antenna (or other style small antenna) and is not necessarily as limited in placement locations as the PCS antenna 20.

In FIG. 1, the PCS antenna 20 is used for transmitting communications signals between the wireless phone 1 and a wireless network base station (not shown) at the PCS frequency band. The Bluetooth antenna 18 is used to establish a short range communication link between the wireless phone 1 and some other portable device, such as a PDA, at the Bluetooth frequency band. Bluetooth communication links are typically 10 meters or less in length. A significant limitation of the configuration of FIG. 1, however, is the Bluetooth antenna is located at a position where a user's hand may interfere with an established Bluetooth communications link, thereby reducing the range of the link. An alternative to the configuration of FIG. 1 is placing the antenna on the top of the phone, as shown in FIG. 2. In FIG. 2, however, although the Bluetooth antenna is located at a position where the potential for interference by the user's hand is minimized, its close proximity to the PCS antenna does not permit proper isolation between the PCS antenna and the Bluetooth antenna. The result of this inadequate isolation is that signals are coupled between the Bluetooth antenna and the PCS antenna. That is, electromagnetic energy produced by the Bluetooth antenna 18, electrically interferes with the operation of the PCS antenna 20, and vice versa.

In general, isolation between closely spaced antennas in other applications is typically controlled by antenna design, antenna locations, and filters. A filter implementation, for example, could include placement of a filter in the path of the Bluetooth antenna for rejecting signals created by the PCS antenna. This filter would prevent electromagnetic energy from the PCS frequency band signals from interfering with the Bluetooth antenna. Another filter could be placed in the path of the PCS antenna to filter the associated Bluetooth frequency signal. This other filter would prevent electromagnetic energy at the Bluetooth frequency band from interfering with the PCS antenna. Typically, filters are networks of inductors and capacitors and are limited by difficult compromises between size and losses to the desired signal. Specifically, filters formed by these inductor/capacitor networks are known in the art as L/C filters. One disadvantage, however, of using an L/C filter to provide isolation between a Bluetooth and a PCS antenna in a wireless phone is the size of the required inductors and capacitors, especially given the restrictive physical dimensions of conventional hand-held wireless phones.

A suitable alternative to using L/C filters is relying on ceramic filters. Ceramic filters can produce essentially the same filter performance characteristics as L/C filters but are much smaller in size for equivalent losses. Ceramic filters are constructed of a plurality of ceramic resonators.

A ceramic resonator is a shorted quarter wavelength coaxial transmission line. At a quarter wavelength, a shorted transmission line has similar electrical characteristics to a parallel resonant inductor and capacitor. A ceramic resonator is one particular type of coaxial transmission line. A ceramic resonator has a ceramic dielectric between coaxial inner and outer conductors. At one end of the ceramic resonator the inner and outer conductors are shorted together by plating that end of the resonator with metal. Ceramic resonators are integral components of ceramic filters.

FIG. 3 illustrates a conventional ceramic resonator 40. The ceramic resonator 40 includes a block of high dielectric ceramic material 19, having a bore 23 therethrough. Ceramic resonators typically have high dielectric constants. For example, typical dielectric constant values are within the range of 20 to 95. A metal core 24, disposed within the bore 23, forms an inner conductor.

FIG. 4 illustrates that an exterior surface of the ceramic resonator 40 is made to be conductive by coating it with a metallic material 25. The metallic material 25 forms the outer conductor. Typically, during fabrication of the resonator, the metal core 24 (inner conductor) and the metallic material 25 may be physically coupled together by the metal plating of the outer surface, one end, and the inner surface all at the same time. That is, the metal plating for the outside surface, the inside surface, and one end are all formed of the same metallic material.

FIG. 5 shows one end 40B of the resonator 40 having an inner conductor 24 and the outer conductor 25 coupled together by a metal end 10. The other end 40A of the resonator 40 includes a connection lead 41A, connected to the outside surface and connection lead 41B, coupled to the metal core 24. The leads 41A and 41B may be used to connect the resonator to an electric circuit.

As stated above, however, conventional ceramic filters include a plurality of ceramic resonators. Therefore, since ceramic filters include large number of ceramic resonator elements, ceramic resonators impose many of the same problems as L/C filters and are therefore an inadequate solution for isolating the antennas used in portable communications devices.

### SUMMARY OF THE INVENTION

There is consequently a need in the art for a way of increasing the electrical isolation between Bluetooth antennas and PCS antennas in handheld portable communication devices without using filters having a large number of components. This need extends to a way that requires fewer components than conventional ceramic filters and/or that introduces relatively little, if any, loss to the PCS and Bluetooth bands. One approach uses a filter to reject a specific frequency, or a rejection notch, in the frequency band of the undesired signal. This can be achieved using a single ceramic resonator element, instead of a conventional ceramic filter. A single ceramic resonator comprises fewer components than its L/C filter counterpart. Additionally, the ceramic material has a much higher dielectric constant than a conventional transmission line and would therefore require much less physical length to be a quarter wavelength long.

Consistent with the principles of the present invention as embodied and broadly described herein, an exemplary embodiment includes a portable communications device structured for communication in a wireless communications network. The device comprises a first circuit configured to produce a first frequency signal and a first antenna structured to be electrically coupled to the first circuit. The first circuit and the first antenna form a first transmission path between the first circuit and the first antenna when the first circuit and the first antenna are electrically coupled together. Also included is at least a second circuit configured to produce at least a second frequency signal. The at least second antenna is structured to be electrically coupled to the second circuit. The second circuit and the second antenna form a second transmission path between the second communications circuit and the second antenna when electrically coupled together. A dielectric resonator is arranged along the first transmission path and configured for filtering effects of the second frequency signal from the first transmission path.

### BRIEF DESCRIPTION OF THE DRAWINGS

The accompanying drawings, which are incorporated in and constitute a part of this specification, illustrate preferred embodiments of the invention and, together with the description, explain the objects, advantages, and principles of the invention. In the drawings:

FIG. 1 illustrates a handheld wireless phone having a Bluetooth antenna mounted at a side location of the phone;

FIG. 2 illustrates the handheld wireless phone of FIG. 1 with the Bluetooth antenna mounted on the top of the phone;

FIG. 3 is a prior art illustration of a ceramic block component of a resonator used in accordance with the present invention;

FIG. 4 is a prior art illustration of the ceramic block of FIG. 3 having a conductive coating element applied to an exterior surface thereof;

FIG. 5 is a prior art illustration of a ceramic resonator with one end of the inner and outer conductor shorted together and the other end configured as connection leads;

FIG. 6 is a functional illustration depicting an exemplary portable communications device in accordance with the present invention;

FIG. 7 illustrates an exemplary ceramic resonator element used in accordance with the present invention;

FIG. 8 illustrates a transmission line model simulating the effects of using a transmission line as an isolation device;

FIG. 9 is a graph contrasting measured isolation and simulated isolation against a predetermined isolation goal; and

FIG. 10 illustrates the antenna isolation improvement realized by using ceramic resonators in accordance with the present invention.

### DETAILED DESCRIPTION OF PREFERRED EMBODIMENTS

The following detailed description of the present invention refers to the accompanying drawings that illustrate exemplary embodiments consistent with this invention. Other embodiments are possible and modifications may be made to the embodiments without departing from the spirit and scope of this invention. Therefore, the following detailed description is not meant to limit the invention.

A ceramic resonator used to reject a signal of an undesired frequency may introduce a desirable impedance to reject the undesired frequency, but introduce undesirable reactance components at the desired frequency. For example, at the rejection frequency band, a ceramic resonator introduces an infinite impedance between the phone and the antenna, which serves to block the transmission of the frequency of interest, that is, the frequency to be rejected. On the other hand, at the desired frequency, the filter introduces some unwanted series reactance. This reactance is compensated for by an antenna matching network. In antenna design, matching networks are generally used to match reactive and resistive components of an antenna's input impedance to the impedance of the antenna's transmission line over a specified frequency range. The antenna matching network may also be used to match performance characteristics of the ceramic resonator to the antenna and transmission line, or in other words, to de-tune any undesirable effects created by the ceramic resonator, such as the series reactance.

Thus, the present invention provides a filtering technique to create a frequency notch at the PCS frequency and the Bluetooth frequency bands using a ceramic resonator. A ceramic resonator provides a small and low loss method for filtering out undesired signals that occur because of antenna coupling. A ceramic resonator achieves these results without using a network of inductors and capacitors. More importantly, the high dielectric constant of the ceramic material allows the resonator to be much shorter than a conventional transmission line and the loss is much less than that of an inductor and capacitor network of the same size. Thus, use of ceramic resonators permits the construction of a better filter circuit for the same size as a filter constructed using inductors and capacitors.

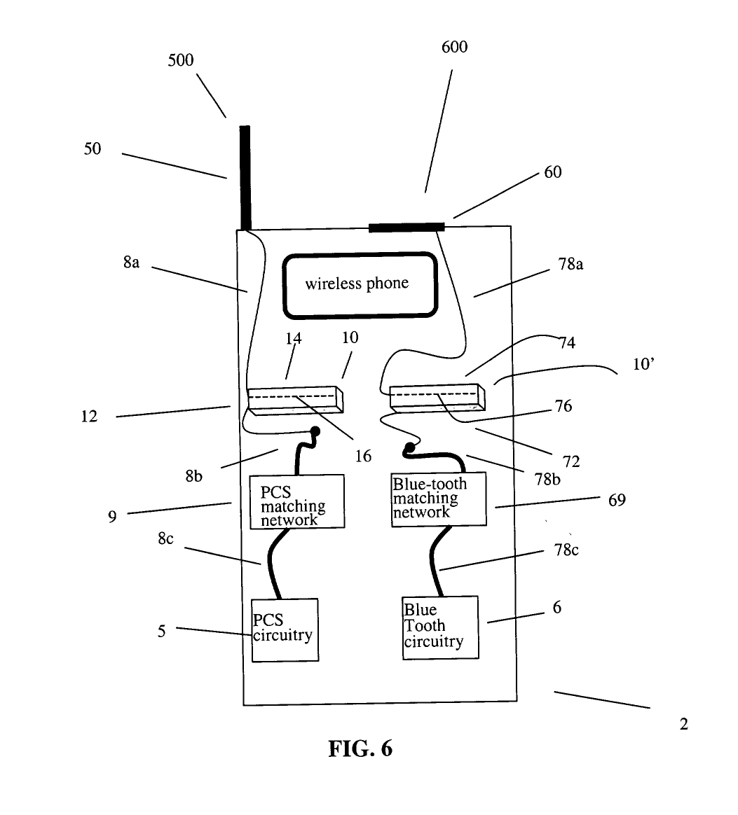

FIG. 6 illustrates an exemplary hand-held personal communications device structured and arranged in accordance with the present invention. In FIG. 6, a wireless phone 2 includes a PCS antenna 50 and a Bluetooth antenna 60, both located on a top portion of the wireless phone 2. Also included are ceramic resonators 12, 72 used respectively with antennas 50 and 60.

In the exemplary embodiment of FIG. 6, the ceramic resonator 12 is inserted in the transmission path to/from the PCS antenna 50, and the ceramic resonator 72 is inserted in the transmission path to/from the Bluetooth antenna 60. Each of the ceramic resonators 12, 72 is configured to create a rejection notch response in the frequency band of an undesired RF signal. Thus, resonator 12 creates a rejection notch in the 2.4 to 2.5 GHz frequency band, the Bluetooth band, and the resonator 72 creates a rejection notch in the 1.85 to 1.99 GHz frequency band, the PCS band. In so doing, the ceramic resonators 12, 72 minimize signal coupling between the PCS antenna 50 and the Bluetooth antenna 60, by increasing the level of electrical isolation between the antennas 50 and 60. Since only one ceramic resonator is required in the path to each of the antennas 50 and 60, the required electrical isolation can be achieved in the limited space afforded by the hand-held wireless phone 2.

Each of the ceramic resonators 12, 72 is essentially a coaxial transmission line that is electrically a quarter wavelength of the rejection frequency, 2.4 to 2.5 GHz and 1.85 to 1.99 GHz respectively. In order to prevent passage of the unwanted signal, each resonator creates an infinite impedance in the particular frequency band to be rejected, thus preventing passage of the unwanted signal. The ceramic resonator 12 is connected to the PCS antenna 50 through a transmission line segment 8a. Similarly, the ceramic resonator 72 is connected to the Bluetooth antenna 60 through a transmission line segment 78a.

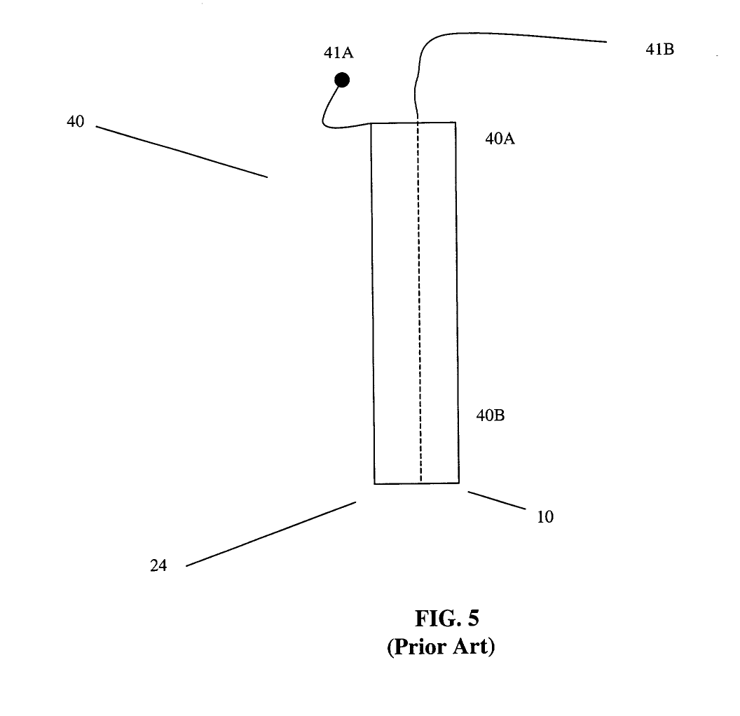

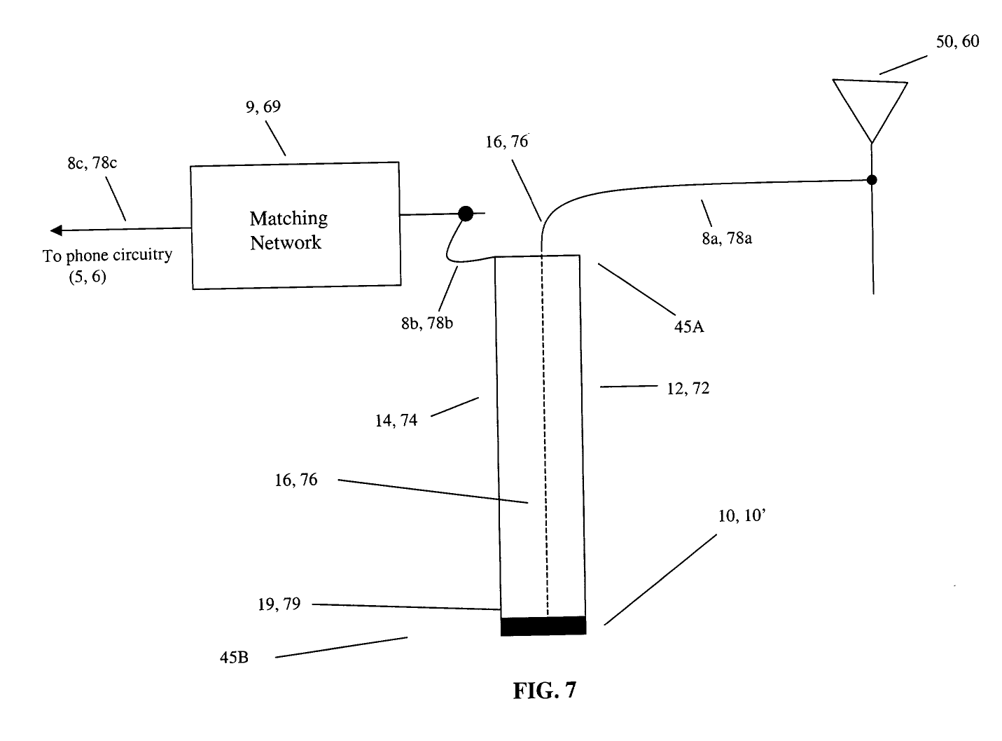

As shown more clearly in FIG. 7, each ceramic resonator 12, 72 is constructed and arranged in a manner similar to the conventional resonator shown in FIG. 5. In particular, the ceramic resonators 12, 72 of the present exemplary embodiment respectively include a ceramic dielectric exterior surface 19, 79, an metallic interior core 16, 76, and an outer conductor 14, 74. At one end 45B of each of the resonators 12, 72, the interior conductor 16, 76, is shorted with the exterior conductor 14, 74 using respective connecting plates 10, 10′.

At the other end 45A of the resonators 12, 72, each of the outer conductors 14, 74 is respectively connected to antenna matching networks 9, 69 using transmission line segment 8b, 78b. Similarly, each of the respective inner conductors 16, 76 at the end 45A, is respectively connected to the antennas 50, 60 through respective transmission line segments 8a, 78a. Finally, transmission line segments 8c, 78c respectively connect the respective matching networks 9, 69 to PCS circuitry 5 and Bluetooth circuitry 6. Thus, one resonator 12 is connected along the PCS antenna path and the other resonator 72 is connected along the Bluetooth antenna path.

Constructed and arranged in the manner above, the exemplary embodiment of the present invention, shown in FIG. 6, operates in the following manner. When the wireless phone 2 is activated, the PCS circuitry 5 and the Bluetooth circuitry 6 also become active. At this time, PCS and Bluetooth signals are permitted to respectively travel along PCS signal path 500 and Bluetooth signal path 600. Along the PCS path 500, PCS communications signals may originate at the PCS circuitry 5 or may be received by the PCS antenna 50. Those PCS signals originating at the PCS circuitry 5 are transmitted along the transmission line segment 8c to the PCS matching network 9. The PCS matching network 9 matches impedance characteristics of the PCS circuitry with impedance characteristics of the transmission line segment 8b and the ceramic resonator 12. Once matched in the PCS matching network 9, the PCS communications signals travel along the transmission line segment 8b, through the ceramic resonator 12, along the transmission line segment 8a and to the PCS antenna 50 where they are emitted. PCS signals received at the PCS antenna 50 travel along the PCS communications path 500 in an opposite direction to signals originating at the PCS circuitry 5.

As stated above, the ceramic resonator 12 is used to create a frequency notch at the Bluetooth frequency band in order to prevent Bluetooth signals traveling along a Bluetooth communications path 600 from coupling to the PCS antenna 50, and interfering with PCS signals traveling along the PCS transmission path 500. The frequency notch of the ceramic resonator 12 preferably rejects only signals at the Bluetooth frequency band. Therefore, PCS signals traveling along the PCS communications path 500 are not effected by the ceramic resonator 12. Bluetooth signals traveling along the Bluetooth communications path 600 are similarly unaffected by the ceramic resonator 72.

Likewise, signals traveling along the Bluetooth path 600 may originate at the Bluetooth circuitry 6 or may be received by Bluetooth antenna 60. Those Bluetooth signals originating at the Bluetooth circuitry 6 are transmitted along the transmission line segment 78c to the Bluetooth matching network 69. The Bluetooth matching network 69 matches impedance characteristics of the Bluetooth circuitry 6 with impedance characteristics of the transmission line segment 78b and the ceramic resonator 72. Once matched in the Bluetooth matching network 69, the Bluetooth communications signals travel along the transmission line segment 78b, through the ceramic resonator 72, along the transmission line segment 78a and to the Bluetooth antenna 60 where they are emitted. Bluetooth signals received at the Bluetooth antenna 60 travel along the Bluetooth communications path 600 in an opposite direction to signals originating at the Bluetooth circuitry 6.

During operation of the handheld wireless phone 2, PCS signals are coupled to the Bluetooth antenna 60 and travel along the Bluetooth communications path 600 due to the close proximity of the PCS antenna 50 and the Bluetooth antenna 60. Similarly, Bluetooth signals are coupled to the PCS antenna 50 and travel along the PCS communications path 500. In the exemplary embodiment of the instant invention, however, Bluetooth signals traveling along the PCS communications path 500 are rejected by the ceramic resonator 12. As stated above, the ceramic resonator 12 is constructed and arranged to be electrically a quarter of the wavelength of signals in the Bluetooth frequency band, 2.4 to 2.5 GHz, thereby rejecting signals in this narrow frequency range. In so doing, however, the ceramic resonator 12 creates some series reactance components, which are then de-tuned by the PCS matching network 9.

Conversely, PCS signals traveling along the Bluetooth communications path 600 are rejected by the ceramic resonator 72. As stated above, the ceramic resonator 72 is constructed and arranged to reject signals in the narrow PCS frequency range of 1.85 to 1.99 GHz. Undesirable reactance components created by the ceramic resonator 72 are de-tuned by the Bluetooth matching network 69.

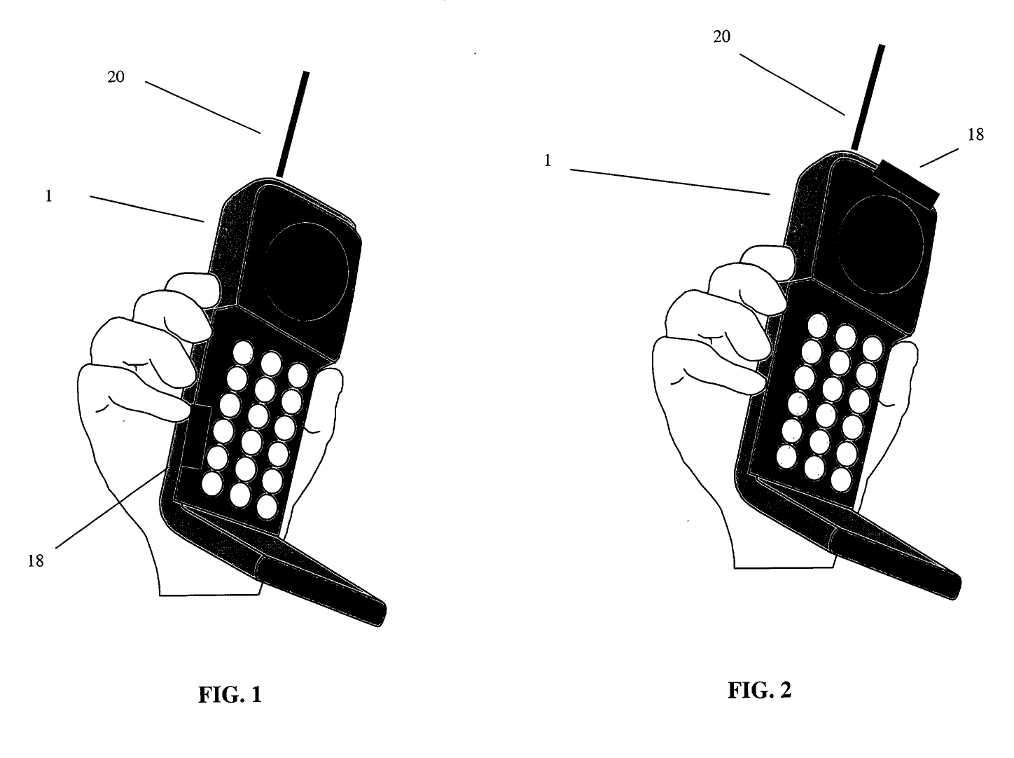

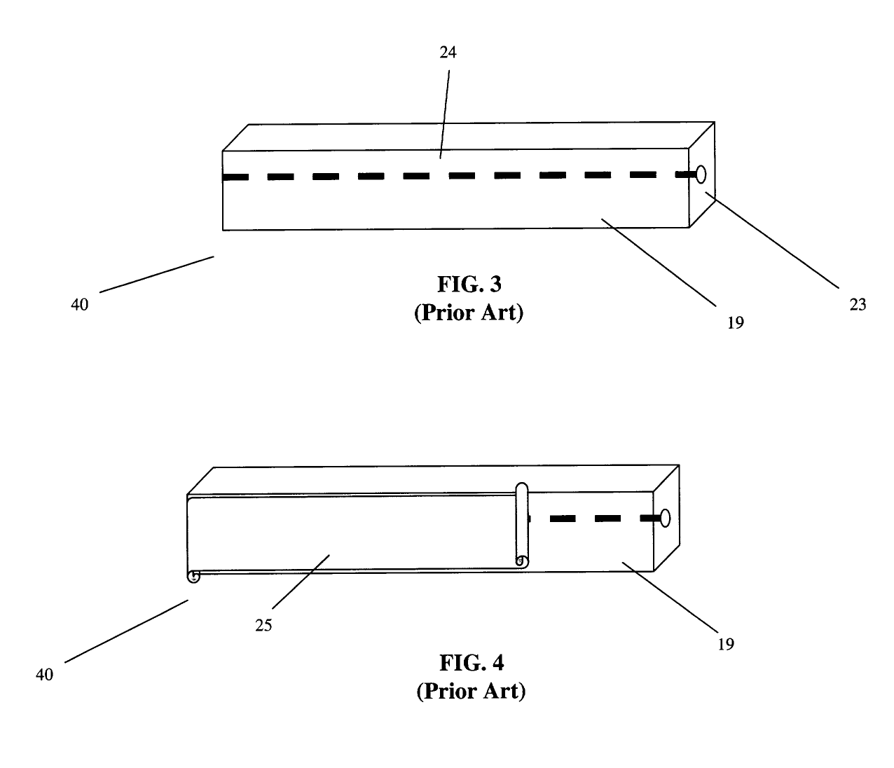

An exemplary implementation of the present invention is provided to enhance the reader's understanding of the invention. In an exemplary embodiment of the present invention, implemented in a hand-held wireless phone, such as the phone 2 of FIG. 6, a hypothetical user may desire certain performance requirements, such as providing at least 20 db isolation in the Bluetooth band and 25 db in the PCS band. Such isolation goals, if achieved, should be enough to solve the antenna coupling problem created when the PCS antenna 50 and the Bluetooth antenna 60 are both mounted on the top of the phone, as shown in FIGS. 2, and 6. As stated above, however, the coupling problem would not be as severe if the Bluetooth antenna 60 was mounted on a side location of the phone, as shown in FIG. 1. The approach of FIG. 1 is undesirable, however, because of typical hand placement which might block the Bluetooth signal.

The inventor has determined through experimentation that the measured isolation between a typical Bluetooth antenna and a typical PCS antenna mounted on the top of a handheld wireless phone, is about 15 dB in the Bluetooth band and 20 dB in the PCS band. Thus, the goals of 20 dB isolation in the Bluetooth band and 25 dB isolation in the PCS band, stated above, are realistic. A hand-held wireless phone constructed and arranged as shown in FIG. 2 would typically be only 5 dB short of the goal at both the Bluetooth band and the PCS band.

The inventor has also determined through a modeling & simulation, that antenna isolation using a standard transmission line, or stripline, requires fewer components than an actual L/C filter and produces slightly better isolation results than the measured performance above. However, the stripline fails to produce the desired degree of isolation, as established by the performance goal described above.

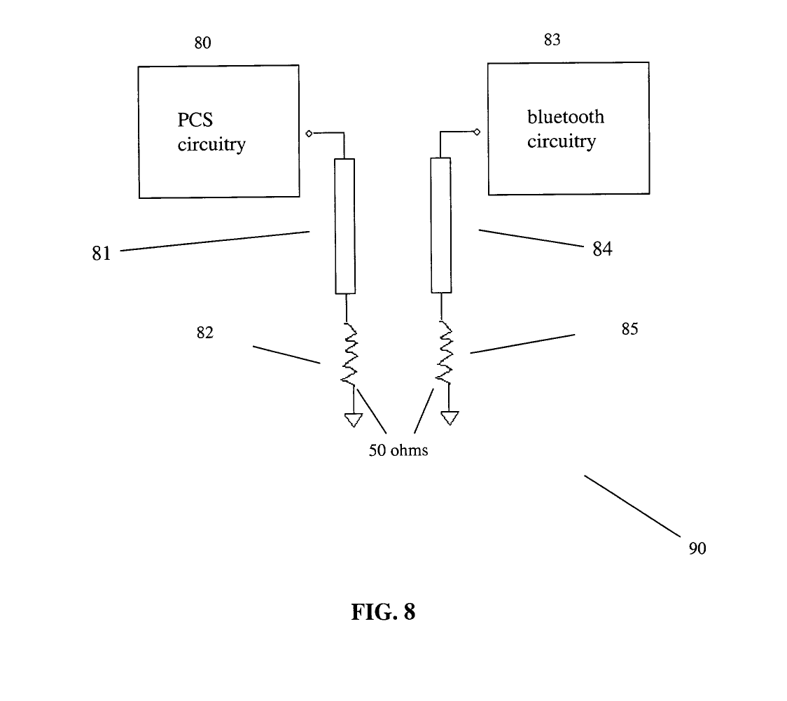

An exemplary model simulation is shown in FIG. 8. Specifically, FIG. 8 illustrates a coupled transmission line model 90 to simulate isolating the Bluetooth antenna 60 from the PCS antenna 50. In the transmission line model 90, PCS circuitry 80 and Bluetooth circuitry 83 are coupled to respective transmission lines 81 and 84. Also resistors 82 and 85, each having a resistance of 50 ohms, are respectively used in the transmission lines 81 and 84 to terminate each transmission line.

The coupling parameters of these transmission lines were chosen to closely match the coupling measured between the PCS and Bluetooth antennas on a prototype phone.

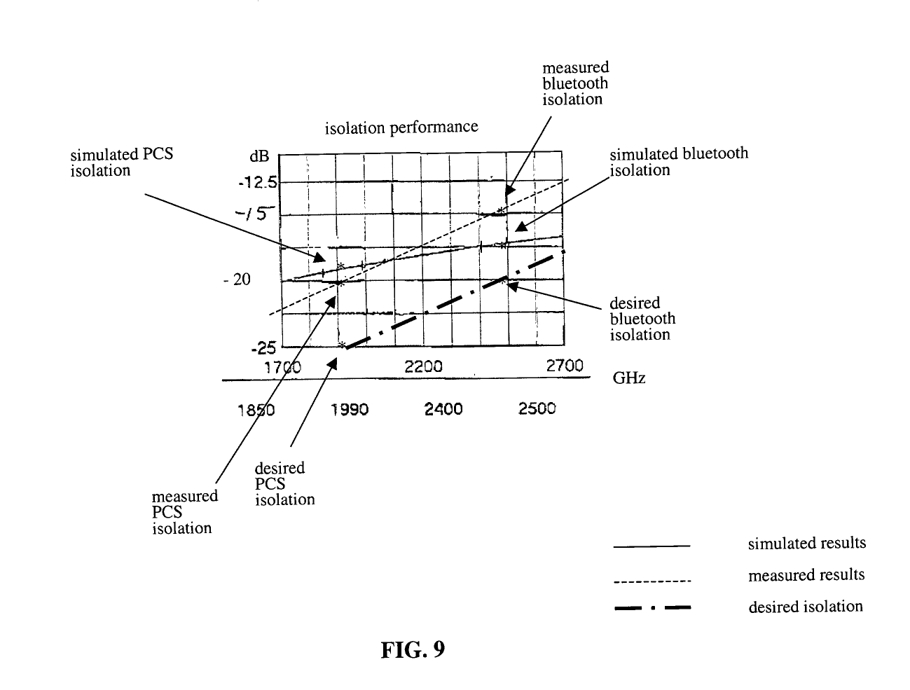

FIG. 9 contrasts measured isolation results and simulated isolation results with the desired performance goals stated above. The measured results were obtained by taking actual isolation measurements from a wireless phone, such as the configuration of FIG. 2, and without any type of filtering. Specifically, FIG. 9 illustrates that the model simulation produced about 19 dB of isolation in the PCS band, while the measured results showed 20 dB of isolation. Therefore, in the PCS band, the measured isolation results were slightly better than the simulated results. In the Bluetooth band, however, the model simulation produced 17.5 dB of isolation and the measured results showed 15 dB of isolation. Thus, in the case of the Bluetooth band, the model simulation produced slightly better results. Neither the model simulation nor the measured results, however, satisfy the goals stated above for providing at least 20 dB and 25 dB of isolation in the Bluetooth band and the PCS band, respectively.

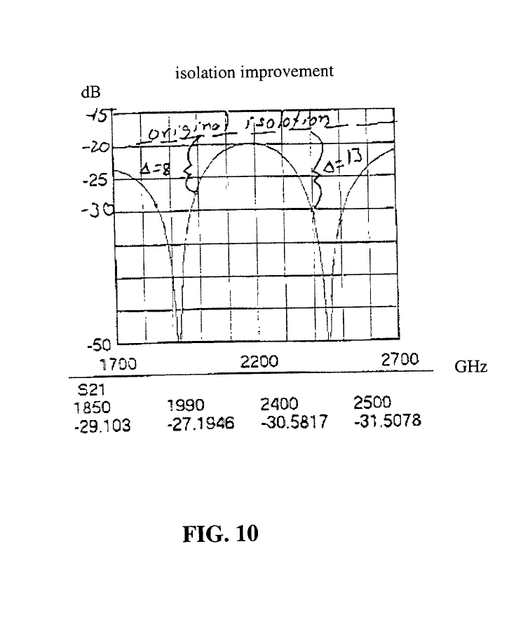

FIG. 10 illustrates, that by using a ceramic resonator to create a frequency notch at the PCS band and the Bluetooth band respectively, improvements in isolation will be realized to sufficiently satisfy the goals stated above. In particular, using the ceramic resonator to add a 1.85 to 1.99 GHz frequency rejection notch to the PCS band and a 2.4 to 2.5 GHz frequency rejection notch to the Bluetooth band, provide the desired isolation.

Parameters of the ceramic resonator, such as characteristic impedance, length, inner diameter, outer diameter, and the like, can be determined using a variety of techniques well known in the art. First, the ceramic material used as the dielectric in ceramic resonators has a high dielectric constant ε which allows for a physically short length. The dielectric constant ε of the ceramic resonator in this example is 45. As noted earlier, typical dielectric constants are within a range of 20 to 95. The following expression shows the relationship between a transmission line's physical length and its dielectric constant ε:

(0.3/F)*(¼)*(1/sqrt (ε))

where:

the result is in units of meters, (F) is the frequency measured in GHz, and (¼) is an expression of the relation between the electrical length of the transmission line and the wavelength of the signal of interest, for example, quarter wavelength, half wavelength, and the like. Thus, it can be seen from this expression that the higher the dielectric constant 6, the lower the physical length of the transmission line.

Using the known techniques discussed above and based upon the dielectric constant ε of the ceramic resonator, a comparable ceramic filter would have the following characteristics:

For the Bluetooth band: physical transmission line length (4.5 mm), Zo (15 ohms) for the Bluetooth band. For the PCS band: physical length: (5.8 mm), Zo (15 ohms). For coaxial transmission lines with circular cross sections the characteristic impedance Zo=(60/sqrt (ε))*(ln(OD/ID), where ln is the natural log, OD is the outside diameter, ID is the inside diameter. Typical ceramic resonators have a circular inner diameter, but the outer conductor has a square cross section with rounded corners. Although more accurate techniques exist for calculating Zo for this case, the formula above is a useful approximation.

The inventor has determined through experimentation, that a comparable ceramic filter constructed and arranged in accordance with the present invention would only add about 0.1 dB of additional loss in the PCS and Bluetooth frequency bands. Although using the ceramic resonator may introduce some series reactance, this reactance can easily be compensated for by the antenna matching network. Antenna matching networks are standard features of antenna systems used with transmission lines and are well known and understood by those skilled in the art.

Therefore, as can be clearly seen from the example above, a ceramic resonator can be an effective tool to isolate the PCS antenna and the Bluetooth antenna in handheld communications devices. When placed in the path of the PCS band and the Bluetooth band, the ceramic resonator creates a frequency notch in the Bluetooth band and PCS band, respectively, thus preventing unwanted coupling interference. Moreover, using a ceramic resonator requires fewer components than conventional L/C filters, and introduces fewer losses into the PCS and Bluetooth bands than standard transmission lines.

It can be readily determined from the foregoing description that the present invention is also applicable to frequency bands other than the exemplary frequency bands identified herein. Additionally, the present invention is also applicable to technologies other than PCS wireless and Bluetooth.

Finally, the foregoing description of the preferred embodiments provides an illustration and description, but is not intended to be exhaustive or to limit the invention to the precise form disclosed. Modifications and variations are possible consistent with the above teachings or may be acquired from practice of the invention.

What we claim is:

1. A portable communications device structured for communication in a wireless communications network, the device comprising:
a first circuit configured to produce a first frequency signal;
a first antenna structured to be electrically coupled to the first circuit, the first circuit and the first antenna forming a first transmission path between the first circuit and the first antenna when the first circuit and the first antenna are electrically coupled together;
at least a second circuit configured to produce at least a second frequency signal;
at least a second antenna structured to be electrically coupled to the second circuit, the second circuit and the second antenna forming a second transmission path between the second circuit and the second antenna when electrically coupled together;
a first dielectric resonator arranged along the first transmission path and configured to filter effects of the second frequency signal from the first transmission path; and
at least a second dielectric resonator arranged along the second transmission path and configured to filter effects of the first frequency signal from the second transmission path.

2. The portable communications device of claim 1, further comprising a matching device structured for detuning effects of adding the first and the at least second dielectric resonators to the respective first and second transmission paths.

3. The portable communications device of claim 1, wherein each of the first and second dielectric resonators includes:
an elongated substantially tubular dielectric body;
a first conductor disposed inside the substantially tubular dielectric body and a second conductor disposed around a peripheral surface of the substantially tubular dielectric body
said body having a coupling end where the first conductor is coupled to the second conductor and an opposite end where the first and second conductor remain electrically unconnected;
wherein one of the first and second conductors of the first resonator is coupled to an antenna side of the first transmission path at the opposite end of the substantially tubular dielectric body and the other of the first and second conductors of the first resonator is coupled at the opposite end of the substantially tubular dielectric body to a circuit side of the first transmission path; and
wherein one of the first and second conductors of the second resonator is coupled to an antenna side of the second transmission path at the opposite end of the substantially tubular dielectric body and the other of the first and second conductors of the second resonator is coupled at the opposite end of the substantially tubular dielectric body to a circuit side of the second transmission path.

4. The portable communications device of claim 1, wherein the first frequency signal is within a frequency range of around 2.4 GHz to 2.5 GHz and wherein the at least second frequency signal includes a frequency range of around 1.85 GHz to 1.99 GHz.

5. The portable communications device of claim 1, wherein the first and second dielectric resonators are ceramic resonators respectively.

6. The portable communications device of claim 1, wherein the first frequency signal is within a wireless telephone frequency band and the second frequency signal is within a Bluetooth frequency band.

7. The portable communications device of claim 1, wherein an electrical length of the first dielectric resonator is a quarter of a wavelength of the second frequency signal and wherein an electrical length of second dielectric resonator is a quarter of a wavelength of the first frequency signal.

8. A method for providing antenna isolation in a portable communications device including at least two antennas, the method comprising:
inserting a first ceramic resonator in a first transmission path to a first of the at least two antennas, the first transmission path being at least between the first antenna and a first frequency circuit which processes signals associated with the first antenna; and
inserting a second ceramic resonator in a second transmission path to a second of the at least two antennas, the second transmission path being at least between the second antenna and a second frequency circuit which processes signals associated with the second antenna;
wherein the first ceramic resonator filters effects associated with the second antenna and wherein the second ceramic resonator filters effects associated with the first antenna.

9. A portable communications device structured for communication in a wireless communications network, the device comprising:
a first circuit configured for producing a first frequency signal;
a first antenna structured to be electrically coupled to the first circuit, the first circuit and the first antenna forming a first transmission path between the first circuit and the first antenna when the first circuit and the first antenna are electrically coupled together;
at least a second circuit configured for producing at least a second frequency signal; and
a dielectric resonator arranged along the first transmission path and configured to filter effects of the second frequency signal from the first transmission path.
